(19) United States
(12) Patent Application Publication
(10) Pub. No.: US 2009/0095668 A1
(43) Pub. Date: Apr. 16, 2009

(54) PREPARATION OF MONOLITHIC ARTICLES

(75) Inventor: Philippe Busson, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: Ge Healthcare Bio-Sciences AB, Uppsala (SE)

(21) Appl. No.: 12/297,377

(22) PCT Filed: May 23, 2007
(86) PCT No.: PCT/SE2007/000499

§ 371 Date: Oct. 16, 2008

(30) Foreign Application Priority Data
May 29, 2006 (SE) 0601230 6

(51) Int. Cl. B01D 15/08; B01J 47/00; H01F 1/42

(52) U.S. Cl. 210/198.2; 521/25; 521/27; 252/62.51 R; 252/62.56

(57) ABSTRACT

The present invention relates to a method of producing a polymeric monolithic article by radical polymerization, which method comprises providing a mold comprising a solution of radically polymerisable monomers; a transition metal catalyst and a complexing ligand in a solvent; adding an ATRP initiator and, optionally, flushing the mixture with an inert gas; carrying out radical polymerisation in the mold; optionally, removing the monolithic article obtained in from the mold; and washing the monolithic article obtained as described above.

### TECHNICAL FIELD

The present invention relates to the preparation of polymeric monolithic articles which are useful as separation materials, and more specifically to a method of polymerizing such monolithic articles. The invention also encompasses the novel polymeric articles as such and their use e.g. in the separation of biomolecules, for cell growth etc.

### BACKGROUND

In the biotech and pharmaceutical field, there is a great need for tools and methodologies which efficiently separate target compounds, such as cells, proteins, drug candidates etc from the environment wherein they were produced. For example, recombinant proteins produced by fermentation needs to be isolated from side products and contaminating substances which are added or produced as the protein is expressed in the fermentation broth. A protocol for the purification of a biotech product often comprises a series of steps, including one or more of e.g. filtration, precipitation and chromatography. Filtration and chromatography techniques can be combined into a step of adsorption to a membrane, for example for capture of contaminants.

Chromatography is a well known technique, which currently occurs as one or more steps in most industrial purification protocols for biotech products. The term chromatography embraces a family of closely related separation methods, which are all based on the principle that two mutually immiscible phases are brought into contact. More specifically, the target compound is introduced into a mobile phase, which is contacted with a stationary phase, often denoted the chromatography matrix. The target compound will then undergo a series of interactions between the stationary and mobile phases as it is being carried through the system by the mobile phase. The interactions exploit differences in the physical or chemical properties of the components in the sample. The chromatography matrix comprises a carrier, to which ligands capable of interacting with the target, are frequently coupled. In order to obtain the optimal separation properties, different formats can be used such as porous or non-porous particles and monolithic plugs. The material of the carrier is carefully selected both due to its potential interaction with the target and due to its flow properties. The latter because chromatographic steps are often run in columns, wherein the chromatography matrix is present in a column and the mobile phase passed across by gravity or pumping. Thus, the matrix should be chosen so as to fulfil requirements of low back pressure, large adsorption capacity etc.

The carrier materials frequently used in chromatography may be grouped as inorganic or organic polymers, wherein the inorganic carriers may be silica; and the organic polymers may be native polymers, such as dextran or agarose, or synthetic polymers obtained by polymerization and optionally cross-linking of monomers or monomer mixtures.

U.S. Pat. No. 5,645,717 (Bio-Rad Laboratories) discloses a continuous, coherent gel plug formed by bulk polymerization of monomers in an aqueous phase in such a way that the polymer chains adhere to each other in bundles with voids or channels formed between the bundles. It has also been discovered that separation media in accordance with this disclosed invention can be compressed to form a more dense bed which offers improved chromatographic performance. However, the compression would result in non-uniform channels in the plug and produce very high back pressures.

U.S. Pat. No. 5,453,185 (Cornell Research Foundation) relates to the production of a continuous macroporous polymer plug containing small pores having diameters less than about 200 nm and large pores with diameters greater than about 600 nm. The porous plug is produced by bulk polymerization of vinyl monomers in the presence of a porogen at elevated temperature. A very high separation efficiency, easiness to prepare and versatility in the selection of monomer chemistry are advantages mentioned for the plug contained in a column. Due to the irregular structure of the pores in the plug and pores with rather small median size, also this plug results in separation at relatively high back pressures.

U.S. Pat. No. 6,328,565 (Varian Inc.) relates to the preparation of a monolithic article, and more specifically to a cross-linked organic polymer prepared with a hydrophobic monomer, a cross-linking agent and a porogenic solvent at 65 deg C. Due to the elevated temperature, temperature diffusion profiles and volume shrinkage may occur during the polymerization, thus rendering the preparation of large supports challenging. The voids are mostly located in between the column wall and polymer due to the difference in surface free energy. The voids are probably occupied by the nitrogen gas generated by azobisisobutyronitrile (AIBN), which is a common initiator for the polymerization.

U.S. Pat. No. 6,736,973 (BIA Separations) discloses a porous self-supporting structure comprising a tube having at least two porous components A and B and the porous component B embraces the porous component A. Components A and B are prepared independently in a mould for casting a tube-like structure and controlling the temperature in a range from 40 deg C. to 90 deg C. Due to the modular approach by stacking thin cylinders to construct large diameter columns for radial flow chromatography, sealing between the discs to form a continuous plug is difficult and time consuming. Moreover, temperature diffusion profiles may occur during the polymerization due to the elevated temperature.

WO 2006/026378 (Applera Corporation) discloses the preparation of a composite substrate comprising a porous copolymer-monolith covalently attached to a surface of a substrate, wherein the porous copolymer-monolith has been formed by an inverse phase photo-copolymerization process. Due to the use of photo polymerization, the preparation of large monolithic articles is difficult and may include the formation of polymerisation diffusion profiles.

U.S. Pat. No. 6,749,749 (Isco Inc.) relates to the preparation of monolithic materials by polymerizationof a mixture while pressure is applied through a piston having a smooth piston head in contact with the polymerization mixture. The pressure eliminates wall effect and changes the structure in the column. Similarly, some columns that have a tendency to swell in the presence of aqueous solutions are pressurized while the solution is applied to prevent swelling and wall effect. This procedure also changes the structure in the column. The size of the separation effective openings can be controlled by the amount of the pressure and pores eliminated. In the light of the described method, production of monolithic elements seems to be difficult since several parameters such as temperature and pressure need to be accurately tuned and controlled.

U.S. Pat. No. 20030155676 discloses the preparation of chromatography columns or capillaries containing sorbents of monolithic mouldings which can remain directly in their gelation mould after production. The dead space arising due to shrinkage between the gelation mould and monolithic article can be compensated by carrying out multiple filling with a monomer solution. One disadvantage with the disclosed invention is that the repeated filling with monomer solution will partially or completely clog the porous system produced during the previous steps.

U.S. Pat. No. 7,025,886 (Sequant AB) relates to the preparation of porous monoliths with high flow permeability that can be produced by polymerising and divinylbenzene in the presence of an initiator, a carboxy-functionalized nitroxide stable free radical and polymeric porogens. The polymerizations are all carried out at 130 deg C., thus polymerization temperature gradients may occurred giving inhomogeneous structures.

U.S. Pat. No. 6,290,853 (Amersham Biosciences) relates to the preparation of a monolithic article, and more specifically to a macroporous cross-linked organic polymer prepared with the so called HIPE technique (High Internal Phase Emulsion). According to this technique a high amount of water is emulsified into the monomer phase, which is the oil phase. The water phase can optionally contain one or more dissolved salts, e.g. sodium chloride, sodium sulphate, ammonium sulphate etc. The emulsion contains at least 75% by weight of water based on the monomer/water composition. Preferably the emulsion contains at least 90% by weight of water phase. The polymerisation of the emulsion results in a material with a very open and regular three dimensional structure. In the polymer structure, an open pore foam-like structure is built up by cavities in the form of spheres with connecting pores between the spheres so that a continuous void or pore phase is formed throughout the matrix. This structure has a low solid content, down to a few percent, but good mechanical qualities. The open structure of the matrix enables a convective flow with very low back pressure even at high flow rates. The pores of the macroporous matrix can be unmodified, or surface modified in a manner, that the convective flow is not hampered. However, the technique used limits the production of large monolithic articles.

WO 2004/003043 (Amersham Biosciences) relates to a method of producing cross-linked polymeric supports of multimodal pore structures, and more specifically to a method of producing a cross-linked polymeric support having a multimodal pore structure, which method comprises providing a degradable initiator molecule; providing an organic phase, which comprises said initiator molecule, radically polymerisable monomers and a porogen in a solvent, and an aqueous phase, which comprises a transition metal catalyst; forming a suspension thereof; starting a suspension polymerisation of the organic phase in the aqueous phase by adding a ligand, which co-ordinates to the transition metal in the aqueous phase via at least one atom; and subjecting the support obtained to degrading conditions to remove the initiator molecule from within the support. The method results in a cross-linked polymeric support having a secondary pore structure in addition to the primary pore structure. Thus, this method uses a controlled radical polymerization, which involves the advantage of improved control of the process. However, the disclosed use of a degradable initiator molecule may in some instances appear cumbersome and time-consuming, as it will require the step of removal. Further, the two-phase suspension polymerization required will render the process more complex than polymerization in a single phase.

Thus, there is a need in this field of alternative and preferably improved methods of preparing chromatography materials, especially monoliths, which methods should be e.g. simpler to carry out and advantageously less time-consuming than the prior art methods.

### BRIEF DESCRIPTION OF THE INVENTION

In one aspect, the present invention relates to the preparation of polymeric monolithic articles by a method which allows improved control over the polymerization as compared to the prior art techniques. This may be achieved by a method as defined in the appended claims.

Another object of the invention is to provide a method of preparing a polymeric monolithic article with reduced or eliminated temperature diffusion profiles during the polymerization. This may be achieved by a method as defined in the appended claims.

A specific object of the invention is to provide a chromatography column comprising a monolithic plug, wherein there is no or very little space between the monolith and the column wall. This may be achieved by a method of wherein the monolith is polymerized in the column using atom transfer radical polymerization (ATRP), as defined in the appended claims.

Further advantages and embodiments will appear from the detailed description that follows and the appended claims.

### BRIEF DESCRIPTION OF THE DRAWINGS

FIG. 1 shows the results of FTIR analysis of a glycidyl methacrylate (GMA)/ethylene glycol dimethacrylate (EGDMA) monoliths according to the invention, prepared as described in Example 1 below.

FIG. 2 shows the results of FTIR analysis of GMA/EGDMA monoliths according to the invention, prepared as described in Example 2 below.

FIG. 3 shows a SEM picture of a GMA/EGDMA monolith according to the invention, prepared as described in Example 2 below.

FIG. 4 shows the results of FTIR analysis of 2-acryloamido-2-methyl-1-propane sulfonic acid (AMPS)/N,N′-methylenebisacrylamide (MBA) monoliths according to the invention, prepared as described in Example 3 below.

FIG. 5 shows a SEM picture of a monolithic plug according to the invention, which was prepared as described in Example 7 below.

FIG. 6 shows a SEM picture of a monolithic plug according to the invention, which was prepared as described in Example 9 below.

FIG. 7 shows a SEM picture of a monolithic plug according to the invention, which was prepared as described in Example 9 below.

### DEFINITIONS

The term “monolith” was originally used for something, such as a column or monument, made from one large block of stone. In the polymer chemistry field, the term is now used for a single polymeric entity, such as a monolithic plug. In the present application, the term “polymeric monolithic article” includes such monolithic plugs, monolithic membranes and any other monolithic article prepared by polymerization in a mold, as described herein.

The term “mold” means herein any vessel, such as a chromatography column, wherein the polymerization according to the invention can be carried out.

The term “ATRP initiator” refers herein to any initiator, which comprises at least one site from which an atom transfer radical polymerisation (ATRP) can be initiated. The term includes initiator molecules of different sizes, such as lower molecular compounds, including dimers, trimers and oligomers. For a general description of ATRP, see e.g. Wang et al. (in J. Am. Chem. Soc., 1995, 36, 2973; and in Macromolecules, 1995, 28, 7572).

The term “macroinitiator” means herein an initiator molecule, which is a macromolecule and which comprises at least one initiating site.

The term “degradable” means in the present context that it is possible to remove by chemical or physical degradation thereof.

The term “porogen” refers to an inert solvent (low molecular weight or polymeric), or a mixture of inert solvents, which is present during a polymerisation reaction wherein it gives rise to formation of a porous polymer at some stage during the polymerisation.

The term “complexing ligand” means herein any organic compound that forms a complex with the transition metal catalyst and thus participates in the atom transfer radical polymerisation (ATRP).

The term “transition metal catalyst” means herein any organic or inorganic compound that forms a complex with the ligand and thus participates in the controlled radical polymerisation.

The phrase “functional groups capable of interacting with a target” means herein any organic compound that confers functionality for chromatography applications such as ion exchange chromatography, reverse phase chromatography, hydrophobic interaction chromatography, affinity chromatography, thiophilic interaction chromatography and others. Such groups are commonly known as “chromatography ligands”, which term, however, in order to avoid confusion with the complexing ligands used in the ATRP process, is not used throughout the present specification.

### DETAILED DESCRIPTION OF THE INVENTION

Thus, in a first aspect, the present invention relates to a method of producing at least one polymeric monolithic article by radical polymerization, which method comprises
(a) in a mold, providing a solution which comprises one or more radically polymerisable monomers, a transition metal catalyst and a complexing ligand in a solvent;
(b) adding an ATRP initiator and, optionally, flushing the mixture with an inert gas, which flushing may be before or after the addition of initiator;
(c) carrying out radical polymerisation in the mold;
(d) optionally, removing the monolithic article obtained in (d) from the mold; and
(e) washing the monolithic article obtained from (c) or in (d).

In an advantageous embodiment, the method according to the invention is carried out in the above order of steps. As the skilled person will understand, there may be provided one or more transition metal catalysts in step (a). As is also understood, in step (a), the phrase “a complexing ligand” means at least one kind of complexing ligand, i.e. a plurality of chemical ligand entities.

The mold may be any vessel, such as a tubular mold or a flat plate-shaped mold. In one embodiment, the mold is a chromatography column and the resulting monolithic article is a plug. In an alternative embodiment, the mold is a flatter shape and the resulting monolithic article is a membrane. Polymeric monolithic articles according to the invention will be discussed in more detail below.

In order to prepare a polymeric article, the monomers present in the organic phase should provide for both polymerisation and cross-linking. The only requirement for the monomers is that they should be radically polymerisable by atom transfer radical polymerization (ATRP) techniques, which is a well known group of monomers to the skilled person in this field. As is easily realised, in order to obtain a cross-linked product, at least one monomer present in the organic phase needs to be multifunctional. Thus, in one embodiment, the monomers are synthetic mono and/or multifunctional monomers. In one embodiment, the monomers are selected from the group consisting of acrylates, methacrylates and acrylamides. In one embodiment, the monomers used are a mixture comprising acrylates, methacrylates and/or acrylamides. As the skilled person will realise, more than one monomer may be used. In addition, any acrylate, methacrylate and/or acrylamide may be used.

In an advantageous embodiment, the organic phase also comprises one or more functional monomers, i.e. monomers that firstly comprise one vinyl group, which will be able to participate in a controlled radical polymerisation, and secondly another functional group, which is not a vinyl group. Such a non-vinyl functional group can e.g. be a hydroxyl, an amine, an epoxy or any other group that can subsequently be used for other purposes than forming the polymeric structure of the support. The skilled person who uses the method according to the invention can easily decide what kind of further functionalities that are needed for each intended purpose. One illustrative such further functionality is an easily accessible chemical handle for further derivatisation of supports intended for use as chromatographic matrices. In another advantageous embodiment, a non-vinyl functional group can be a ligand e.g. a primary amine group, a secondary amine group, a tertiary amine group, a quaternary amine group, a carboxylic acid group or any other group that can be used for the preferred chromatographic steps.

If a porous monolithic article is to be prepared, the organic phase will also comprise at least one solvent. In one embodiment, the solvent will also act as porogen. In an alternative embodiment, at least one porogen is added to the organic phase before the polymerisation. Suitable porogens for use in this context are well known in this field, and the skilled person can easily make a selection among the commercially available products. In a specific embodiment, the porogen is an alcohol. In an advantageous embodiment, the porogen is selected from the group consisting of methanol, ethanol, 2-octanol, cyclohexanol and decanol. In another advantageous embodiment, the porogen is DMF and water. In another embodiment, the porogen is a mixture of solvent. In an alternative embodiment, a template particle or droplet is added to the method, which template is removed once the polymerization resulting in a pore structure instead of template . The use of template particles/droplets to this end is well known by the skilled person in this field. Further, as the skilled person in this field will realise, the pore structure will also be affected by components of the monomer feed. The present method may be run to provide basically any pore size. In an advantageous embodiment, the method provides monolithic articles which present pores ≦500 μm in diameter, such as ≦100 μm in diameter.

The initiator molecule provided in step (c) is advantageously obtained from commercial sources. For example, low molecular initiator molecules, such as 1-phenylethyl chloride or ethyl 2-bromoisobutyrate, are available e.g. from Acros or Aldrich. The initiator molecules can be inorganic or organic molecules, but are preferably organic compounds. In the present method, step (c) is understood to provide either one kind of initiator molecule or a mixture of two or more different initiator molecules.

The transition metal catalyst provided in step (a) can be any transition metal compound that can participate in a redox cycle with the initiator and dormant polymer chain, but which does not form a direct carbon-metal bond with the polymer chain, is suitable for use in the present method. Thus, in one embodiment, the transition metal present is selected from the group that consists of Cu, Ni, Pd, Ru and Fe. In a preferred embodiment, the transition metal is copper (Cu), such as Cu(I) or Cu(II).

Suitable complexing ligands for use in the present invention include ligands having one or more nitrogen, oxygen, phosphorous and/or sulphur atoms that can co-ordinate to the transition metal catalyst through a sigma-bond; ligands that contains two or more carbon atoms that can co-ordinate to the transition metal through a π-bond; and ligands that can co-ordinate to the transition metal through an α-bond or a β-bond (are these bonds correct). Accordingly, in one embodiment, the complexing ligand comprises one or more N, O, P, S or C atoms that co-ordinate to the transition metal in the catalyst. In a specific embodiment, the complexing ligand is N,N,N′,N′,N″-pentamethyldiethylene triamine. As the skilled person in this field will realise the complex will be comprised of a transition metal catalyst complexed to a complexing ligand, which complexing will take place more or less immediately after the complexing ligand has been added to the organic phase containing the transition metal catalyst. The amount of complexing ligand may be selected such that the ratio of (i) co-ordination sites on the transition metal catalyst to (ii) co-ordination sites, which the complexing ligand will occupy, is from 0.1:1 to 100:1, such as 0.8:1 to 2:1.

Accordingly, the polymerisation can be performed at virtually any temperature below that where a substantial part of the organic phase will boil. However, in an advantageous embodiment, in order to avoid temperature diffusion profiles in the product, the heating is kept to a minimum. Thus, in a specific embodiment, the polymerization is carried out at a temperature ≦40° C., such as ≦30° C. In a more specific embodiment, the temperature is about room temperature, such as in the range of 15-25° C. Thus, the temperature may e.g. be ambient temperature, and the reaction time can be any period of time between about 1 minute and up to several days, such as overnight. In the most advantageous embodiment, the temperature is at or about room temperature, i.e. about 18-20° C.

As appears from the above, the present method is carried out as a controlled radical polymerization, and more specifically as atom transfer radical polymerization (ATRP). Thus, the polymerisation is started by addition of a complexing ligand that co-ordinates to the transition metal catalyst, whereby a complex is formed. As is well known, in ATRP, the initiation system is based on the reversible formation of growing radicals in a redox reaction between various transition metal compounds and an initiator.

In one embodiment, the present method includes a washing step, preferably by flushing, subsequent to the polymerization during which porogen and/or ligand-metal complex and/or residual components are washed from the monolithic structure. The skilled person in this field can easily select the suitable washing liquid, such as methanol, ethanol, acetic acid, hydrochloric acid, water.

In a specific embodiment, the present method is used to prepare a magnetic polymeric monolithic article. Thus, in this embodiment, the magnetic component is added to the organic phase before the addition of ATRP initiator, in an amount which results in a magnetic monolithic article. In one embodiment, the mixture resulting from step (a) is flushed before the addition of initiator, in which case the magnetic component may be added before or after said flushing.

The magnetic component may be based e.g. on iron, or on any other suitable metal. Thus, in one embodiment, the magnetic component is selected from the group consisting of Fe₃O₄; γ-Fe₂O₃; Fe; and Fe alloys. In a specific embodiment, the magnetic monolith prepared according to the invention comprises Fe₃O₄.

In an advantageous embodiment, the method according to the present invention comprises an additional step of selective surface modification of the monolithic article so obtained. In the most advantageous embodiment, the surface modification comprises functionalization with pendant groups capable of interacting with a target during a subsequent use. Such pendant groups are commonly known as chromatography ligands, and may be charged, such as anion or cation exchange chromatography ligands; may be hydrophobic, known as hydrophobic interaction chromatography (HIC) ligands; multimodal, i.e. a combination e.g. of charged and hydrophobic groups; or based on biological affinity interactions, such as antibody-antigen interaction, biotin-avidin interaction etc. The skilled person in this field can easily select and couple the desired pendant group using standard methods which are well known. In another embodiment, the surface modification comprises functionalization by atom transfer radical polymerisation starting from the inherent initiator groups present in the monolithic structure. In a further embodiment, the surface is modified by polymerisation of linear or cross-linked polymer. In a preferred embodiment, the polymerization is achieved by atom transfer radical polymerisation (ATRP) utilizing the initiator inherent to the monolithic structure.

In a second aspect, the present invention relates to a chromatography column which is prepacked with a polymeric monolithic article prepared according to any one of the preceding claims, wherein the monolith was polymerized in the column. In the most advantageous embodiment, the polymerization is carried out within the column at or close to room temperature, in which case the resulting monolith will fit snugly in the column, as temperature differentials will be substantially eliminated. Thus, the advantage of this embodiment is that the well known problem of voids between the monolith and the column wall is avoided.

A specific aspect of the invention is a matrix or column according to the invention, which has been sterilized. Thus, this embodiment may be used as a disposable product, which is advantageous especially to remove infectious or toxic components from a process. For example, if the product is a recombinant protein, the disposable product according to the invention may be used to remove virus from the process. The advantage of this process is that the sterility of the monolith will be desired in a pharmaceutical process, while the disposable nature of the monolith makes cleaning and recovery thereof redundant. Thus, this embodiment is advantageously used in processes run under aseptic conditions.

In a third aspect, the present invention relates to the use of a chromatography column or matrix prepared according to the invention in a process of purifying large biomolecules such as plasmids and/or virus or cells. As is well known monoliths are advantageously used in process scale purification, and/or for the purification of large target molecules, as the relative rigidity thereof makes their flow properties suitable to this end. In addition, the ATRP according to the invention allows the definition of the monolith morphology by careful control of the amount and/or nature of initiator. Alternatively or additionally, the nature of the monolith may be decided by controlling the composition of the monomer feed to the polymerisation process. However, as the skilled person in this field will realise, the present chromatography matrix may be used to separate any bio molecule or organic molecule, such as proteins, peptides, nucleic acids, such as oligonucleotides of DNA or RNA, viruses, carbohydrates, lipoprotoeins etc. As cells are large entities, the advantages discussed above of the present matrix will be pronounced in cell separation processes.

In a fourth aspect, the invention relates to a polymeric monolithic article prepared as discussed above, which consists of at least one magnetic monolithic article to which ligands have been coupled. In a preferred embodiment, the ligands are affinity ligands. Such magnetic monolithic articles may be used in methods for isolation and purification of target molecules, as discussed above in the context of the chromatography matrix. An especially advantageous embodiment is a magnetic monolithic article wherein the pore size has been adapted for cell separation, such as stem cells and/or differentiated cells. In a specific embodiment, the magnetic monolith is comprised of a degradable material.

Thus, in a last aspect, the invention relates to the use of the magnetic article according to the invention as a separation matrix. An alternative embodiment is the use of the magnetic article according to the invention as a carrier for cell culture. In this embodiment, the monolith surface will be modified with pendant groups that enhance the attachment of cells which present adherent growth characteristics. The monolith is e.g. useful to expand the number of cells before its use in therapy, such as the expansion of stem cells before cell therapy. Obviously, the invention is equally useful for research purposes.

### DETAILED DESCRIPTION OF THE DRAWINGS

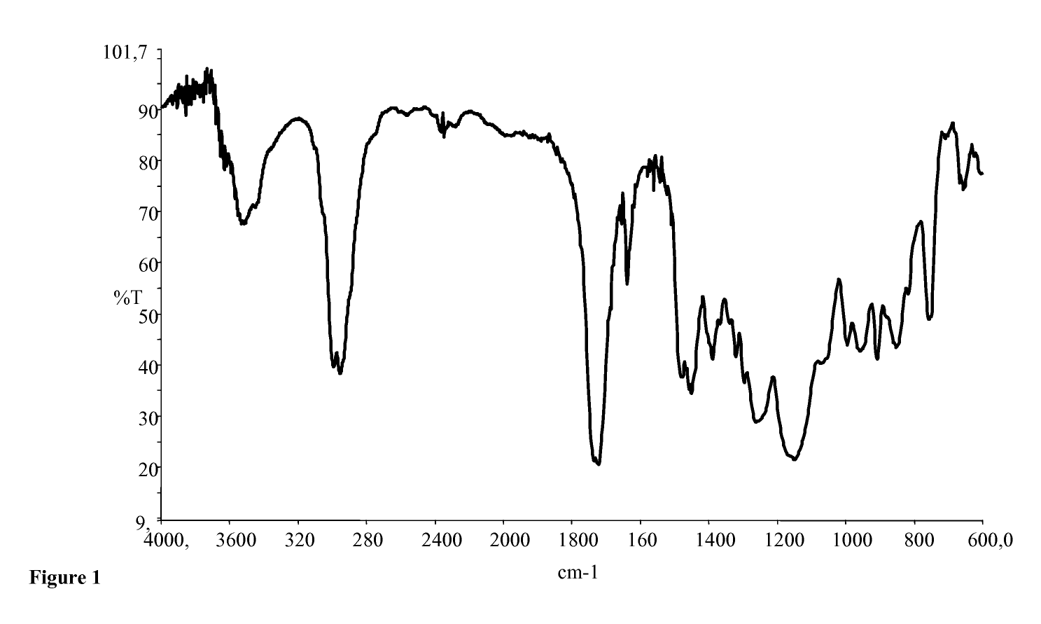

FIG. 1 shows the results of FTIR analysis of a glycidyl methacrylate (GMA)/ethylene glycol dimethacrylate (EGDMA) monoliths according to the invention, prepared as described in Example 1 below by ATRP at room temperature, using 1-decanol as porogen. The spectrum shows characteristic peaks for the different components.

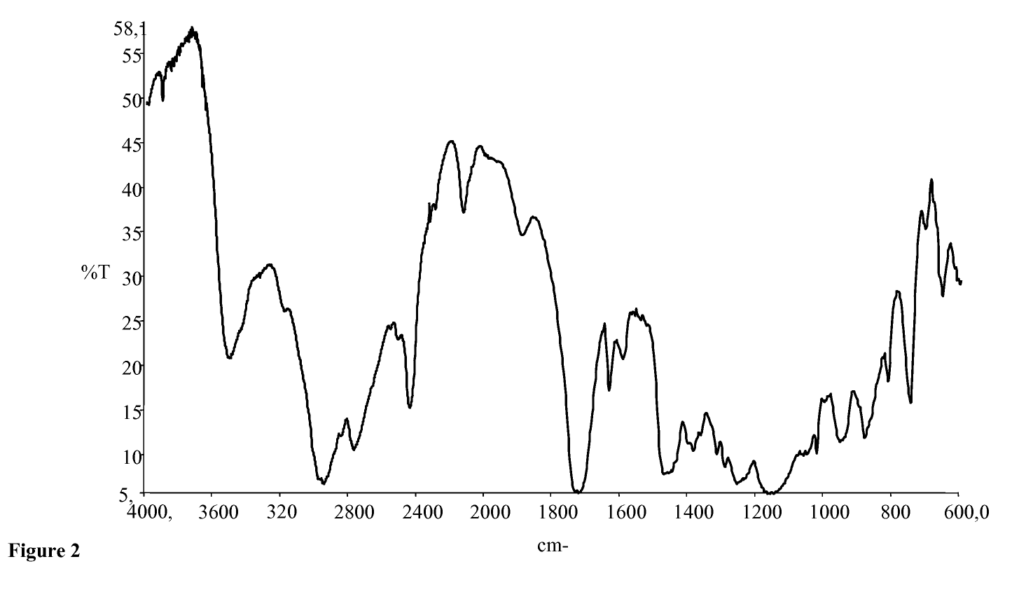

FIG. 2 shows the results of FTIR analysis of GMA/EGDMA monoliths according to the invention, prepared as described in Example 2 below by ATRP at room temperature, using 1-decanol as porogen. The spectrum shows characteristic peaks for the different components.

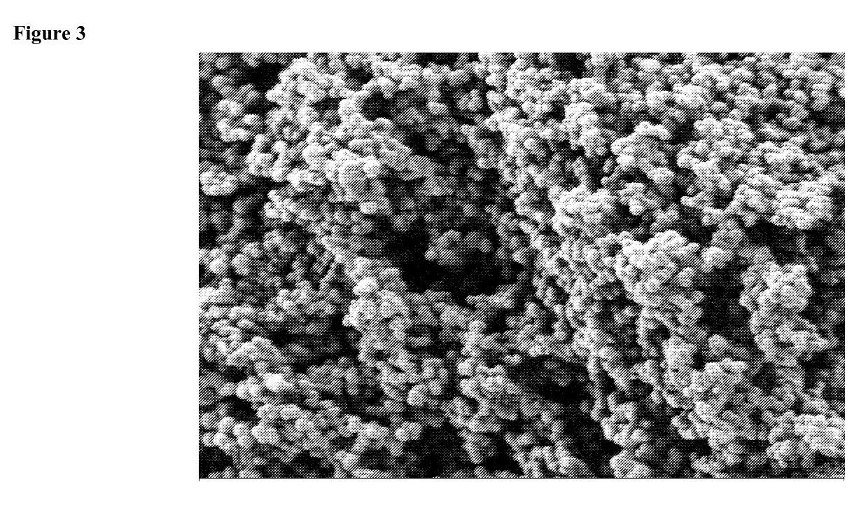

FIG. 3 shows a SEM picture of a GMA/EGDMA monolith according to the invention, prepared as described in Example 2 below by ATRP at room temperature, using cyclohexanol as porogen. Pores having diameters in the range “0” −70 μm can be observed. (In this context, the citation marks (“”) around the FIG. 0 are used to illustrate that even though substantially no pores are present, it is very rare not to have any extremely small pores at all. Thus, the pore diameter “0” means herein that in practise, the pores are hardly existent)

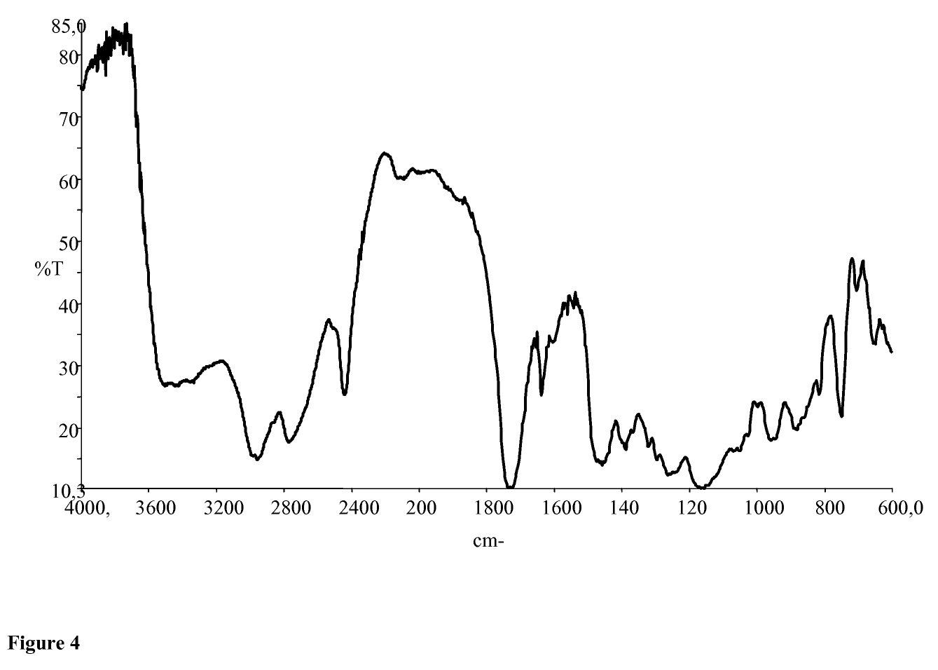

FIG. 4 shows the results of FTIR analysis of GMA/EGDMA monoliths according to the invention, prepared as described in Example 3 below by ATRP at room temperature, using cyclohexanol as porogen. The spectrum shows characteristic peaks for the different components.

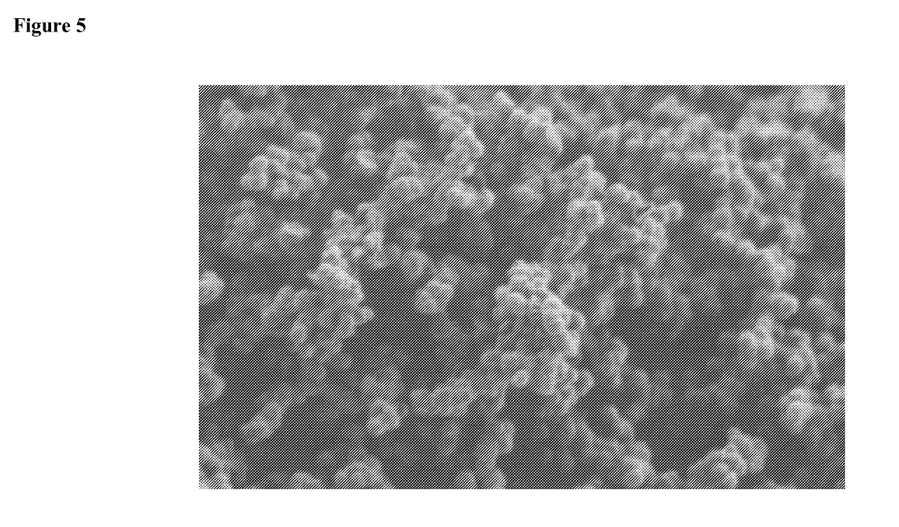

FIG. 5 shows a SEM picture of an AMPS/EGDMA monolithic plug according to the invention, which was prepared as described in Example 7 below by ATRP at room temperature, using ethanol, water and DMF as porogens. Pores having diameters in the range “0” −10 μm can be observed.

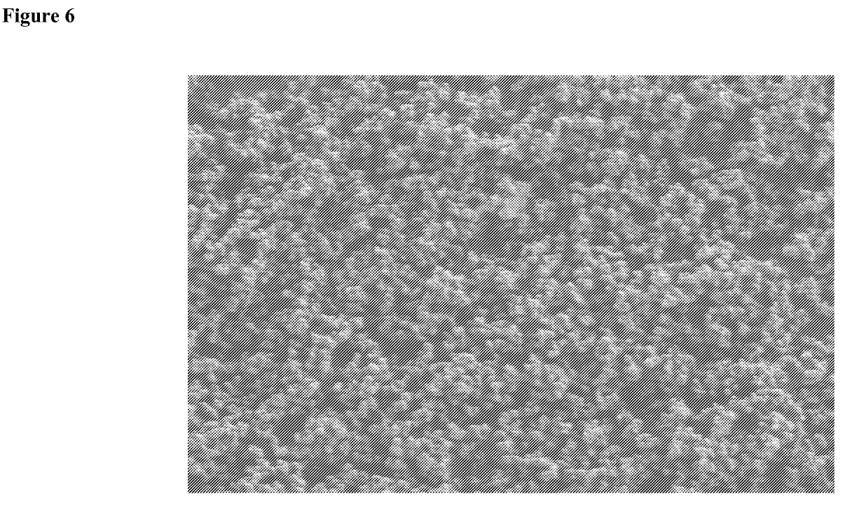

FIG. 6 shows a SEM picture of a HEMA/EGDMA monolithic plug according to the invention, which was prepared as described in Example 9 below by ATRP at room temperature, using 1-decanol as porogen. Pores having diameters in the range “0” −50 μm can be observed.

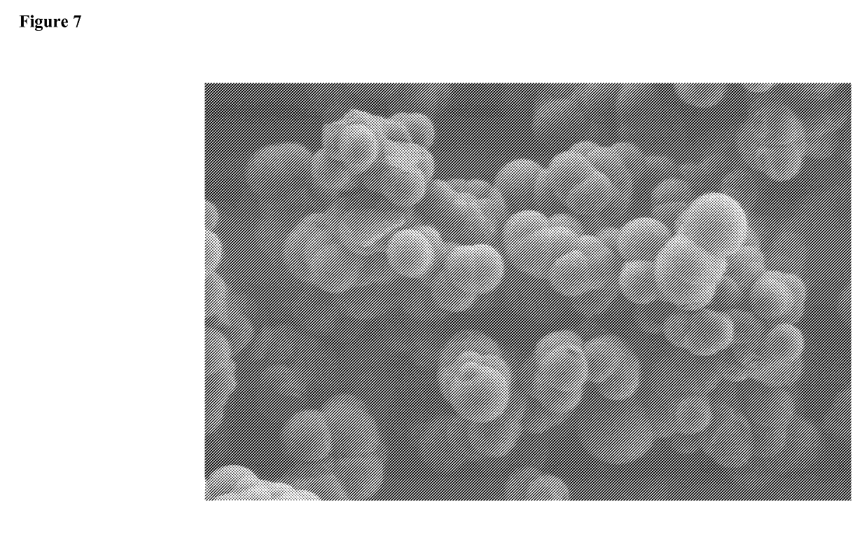

FIG. 7 shows a SEM picture of a HEMA/EGDMA monolithic plug according to the invention, which was prepared as described in Example 9 below by ATRP at room temperature, using 1-decanol as porogen. The bed consists of aggregated particles with a diameter of around 5 μm.

### EXPERIMENTAL PART

The present invention will be described in more detail by way of examples, which however are in no way intended to limit the scope of the present invention as defined by the appended claims. All references given below or elsewhere in the present specification are hereby included herein by reference.

### Example 1

### Preparation of glycidyl methacrylate (GMA)/Ethylene glycol dimethacrylate (EGDMA) monoliths by room temperature ATRP using 1-decanol as porogen

GMA (2.84 g), EGDMA (11.88 g), pentamethyldiethylene triamine (PMDETA) (0.173 g), 1-decanol (14.72 g) and copper bromide (CuBr) (0.143 g) were mixed in a glass vial under nitrogen flow. Ethyl 2-bromoisobutyrate (EBIB) (0.195 g) was added and the vial was sealed. The reaction was allowed to proceed at room temperature overnight. A blue/green plug was obtained which was extensively washed with ethanol, acetic acid and water to provide a white plug. The plug was analysed by FTIR (FIG. 1)

### Example 2

### Preparation of GMA/EGDMA monoliths by room temperature ATRP using 1-decanol as porogen

GMA (6 g), EGDMA (6 g), PMDETA (0.125 g), 1-decanol (8 g) and CuBr (0.102 g) were mixed in a glass vial under nitrogen flow. EBIB (0.1404 g) was added and the vial was sealed. The reaction was allowed to proceed at room temperature overnight. A blue/green plug was obtained which was extensively washed with ethanol, acetic acid and water to provide a white plug. The plug was analysed by FTIR (FIG. 2) and SEM (FIG. 3)

### Example 3

### Preparation of GMA/EGDMA monoliths by room temperature ATRP using cyclohexanol as porogen

GMA (6 g), EGDMA (6 g), PMDETA (0.125 g), cyclohexanol (8 g) and CuBr (0.102 g) were mixed in a glass vial under nitrogen flow. EBIB (0.1404 g) was added and the vial was sealed. The reaction was allowed to proceed at room temperature overnight. A blue/green plug was obtained which was extensively washed with ethanol, acetic acid and water to provide a white plug. The plug was analysed by FTIR (FIG. 4)

### Example 4

### Preparation of 2-acrylamido-2-methyl-1-propane sulfonic acid (AMPS)/N,N′-methylenebisacrylamide (MBA) monoliths by room temperature ATRP using ethanol, decanol, DMF and water as porogens

The sodium salt of AMPS was prepared by mixing AMPS (20 g) in water (30 ml) and adjusting the pH to 8.5 by addition of a 0.5 M aqueous solution of sodium hydroxide. The salt (NaAMPS) was obtained by removal of the water by freeze drying. MBA (1 g), NaAMPS (1 g), PMDETA (0.017 g), 1-decanol (1 g), ethanol (1 g), DMF/water (10 ml, 50/50 in weight) and CuBr (0.015 g) were mixed in a glass vial under nitrogen flow. EBIB (0.02 g) was added and the vial was sealed. The reaction was allowed to proceed at room temperature overnight. A blue/green plug was obtained which was extensively washed with ethanol, acetic acid and water to provide a white plug. The plug was analysed by SEM.

### Example 5

### Preparation of AMPS /EGDMA monoliths by room temperature ATRP using DMF and water as porogens

EGDMA (4.35 g), NaAMPS (2.9 g), PMDETA (0.06 g), DMF/water (7.25 g, 50/50 in weight) and CuBr (0.05 g) were mixed in a glass vial under nitrogen flow. EBIB (0.067 g) was added and the vial was sealed. The reaction was allowed to proceed at room temperature overnight. A blue/green plug was obtained which was extensively washed with ethanol, acetic acid and water to provide a white plug. The plug was analysed by SEM.

### Example 6

### Preparation of 2-hydroxyethyl methacrylate (HEMA)/EGDMA monoliths by room temperature ATRP using 1-decanol as porogen

HEMA (10 g), EGDMA (10 g), PMDETA (0.1102 g), 1-decanol (13.33 g) and CuBr (0.0911 g) were mixed in a glass vial under nitrogen flow. EBIB (0.1242 g) was added and the vial was sealed. The reaction was allowed to proceed at room temperature overnight. A blue/green plug was obtained which was extensively washed with ethanol, acetic acid and water to provide a white plug. The plug was analysed by SEM.

### Example 7

### Preparation of AMPS/EGDMA monoliths by room temperature ATRP using ethanol, water and DMF as porogens

NaAMPS (5 g), EGDMA (5 g), PMDETA (0.081 g), DMF/water (5 g, 50/50 in weight), ethanol (5 g) and CuBr (0.067 g) were mixed in a glass vial under nitrogen flow. EBIB (0.091 g) was added and the vial was sealed. The reaction was allowed to proceed at room temperature overnight. A blue/green plug was obtained which was extensively washed with ethanol, acetic acid and water to provide a white plug. The plug was analysed by SEM (FIG. 5)

### Example 8

### Preparation of GMA/EGDMA monoliths by room temperature ATRP using 1-decanol as porogen

GMA (19.6 g), EGDMA (29.4 g), PMDETA (0.496 g), 1-decanol (49 g) and CuBr (0.41 g) were mixed in a glass reactor under nitrogen flow. EBIB (0.56 g) was added and the reactor was sealed. The reaction was allowed to proceed at room temperature overnight. A blue/green plug was obtained which was extensively washed with ethanol, acetic acid and water to provide a white plug. The plug was analysed by SEM.

### Example 9

### Preparation of HEMA/EGDMA monoliths by room temperature ATRP using 1-decanol as porogen

HEMA (66.66 g), EGDMA (100 g), PMDETA (1.76 g), 1-decanol (166.66 g) and CuBr (1.46 g) were mixed in a glass reactor under nitrogen flow. EBIB (1.985 g) was added and the reactor was sealed. The reaction was allowed to proceed at room temperature overnight. A blue/green plug was obtained which was extensively washed with ethanol, acetic acid and water to provide a white plug. The plug was analysed by SEM (FIG. 6 and FIG. 7)

### Example 10

### Preparation of HEMA/EGDMA monoliths by room temperature ATRP using 1-decanol as porogen

HEMA (3 g), EGDMA (2 g), PMDETA (0.0346 g), 1-decanol (3.33 g) and CuBr (0.0287 g) were mixed in a glass vial under nitrogen flow. EBIB (0.0396 g) was added and the vial was sealed. The reaction was allowed to proceed at room temperature overnight. A blue/green plug was obtained which was extensively washed with ethanol, acetic acid and water to provide a white plug. The plug was analysed by SEM.

### Example 11

### Preparation of HEMA/EGDMA magnetic monoliths by room temperature ATRP using 1-decanol as porogen

HEMA (3 g), EGDMA (2 g), PMDETA (0.0346 g), 1-decanol (3.33 g), iron oxide (1 g) and CuBr (0.0287 g) were mixed in a glass vial under nitrogen flow. EBIB (0.0396 g) was added and the vial was sealed. The reaction was allowed to proceed at room temperature overnight. A blue/green plug was obtained which was extensively washed with ethanol, acetic acid and water to provide a white plug containing iron oxide.

1. A method of producing at least one polymeric monolithic article by radical polymerization, which method comprises
(a) in a mold, providing a solution, which comprises one or more radically polymerisable monomers, a transition metal catalyst and a complexing ligand in a solvent;
(b) adding an ATRP initiator and, optionally, flushing the mixture with an inert gas, which flushing may be before or after the addition of initiator;
(c) carrying out radical polymerisation in the mold;
(d) optionally, removing the monolithic article obtained in (d) from the mold; and
(e) washing the monolithic article obtained from (c) or in (d).

2. The method of claim 1, wherein the mold is a chromatography column.

3. The method of claim 1, wherein the resulting monolithic article is a plug.

4. The method of claim 1, wherein the resulting monolithic article is a membrane.

5. The method of claim 1, wherein the radically polymerisable monomers are synthetic mono and/or multifunctional monomers.

6. The method of claim 5, wherein the monomers are selected from the group consisting of acrylates, methacrylates and acrylamides, or a mixture thereof.

7. The method of claim 1, wherein at least one porogen is added to the solution.

8. The method of claim 7, wherein one porogen is an alcohol.

9. The method of claim 1, wherein the initiator is degradable, and the method comprises a step of removing the initiator after the polymerization.

10. The method of claim 1, wherein the transition metal catalyst is selected from the group that consists of Cu, Ni, Pd, Ru and Fe.

11. The method of claim 1, wherein the complexing ligand comprises one or more N, O, P, S or C atoms that coordinated to the transition metal catalyst to form a complex.

12. The method of claim 1, wherein the radical polymerization is carried out at a temperature ≦40° C.

13. The method of claim 1, wherein the radical polymerization is carried at a temperature in the range of 15-25° C.

14. The method of claim 1, which includes a washing step subsequent to the polymerization during which washing porogen and/or complexing ligand-transition metal catalyst and/or residual components.

15. The method of claim 1, wherein the monolithic article comprises a magnetic component.

16. The method of claim 15, wherein the magnetic component is added to the organic phase before the addition of ATRP initiator in an amount which results in substantially magnetic monolithic articles.

17. The method of claim 1, wherein the magnetic component is Fe₃O₄.

18. A method of preparing a chromatography matrix, comprising the method of claim 1, and an additional step of selective surface modification of the monolithic article so obtained.

19. (canceled)

20. The method of claim 18, wherein the surface modification comprises functionalization with groups capable of interacting with a target.

21. A chromatography column which is prepacked with a monolithic article prepared according to claim 1, wherein the monolith article was polymerized in the column.

22. A chromatography column which is packed with a monolithic article prepared according to claim 1.

23. The column of claim 22, which column has been sterilized.

24. (canceled)

25. A monolithic article prepared according to claim 1, consisting of at least one magnetic monolithic article to which ligands have been coupled.

26. (canceled)
